(19) United States
(12) Patent Application Publication
(10) Pub. No.: US 2024/0371029 A1
(43) Pub. Date: Nov. 7, 2024

(54) AUTOMATIC DETECTION AND TRACKING OF PALLET POCKETS FOR AUTOMATED PICKUP

(71) Applicant: Oceaneering International, Inc., Houston, TX (US)

(72) Inventors: Chiun-Hong CHIEN, Houston, TX (US); Arun Kumar DEVARAJULU, Pittsburg, PA (US); Alexander HUNTER, Baltimore, MD (US); Siddharth SRIVATSA, Baltimore, MD (US); Sai Vineeth Katasani VENKATA, Sharpsburg, MD (US)

(73) Assignee: Oceaneering International, Inc., Houston, TX (US)

(21) Appl. No.: 18/777,368

(22) Filed: Jul. 18, 2024

Related U.S. Application Data
(62) Division of application No. 17/336,516, filed on Jun. 2, 2021.
(60) Provisional application No. 63/033,513, filed on Jun. 2, 2020.

(51) Int. Cl. G06T 7/73; B66F 9/06; B66F 9/075; G06T 7/50; G06V 10/26; G06V 10/44; G06V 10/77; G06V 20/58; G06V 30/19

(52) U.S. Cl. CPC G06T 7/73; B66F 9/063; B66F 9/0755; B66F 9/07559; B66F 9/07568; G06T 7/50; G06V 10/26; G06V 10/44; G06V 10/77; G06V 20/58; G06V 30/19107; G06T 2207/10028

(57) ABSTRACT

A system for directing a vehicle using detected and tracked pallet pocket comprises the vehicle, a navigation system, and a command system which detect and track a pallet pocket during automated material handling using the vehicle where load positions vary and are not accurately known beforehand.

### RELATION TO OTHER APPLICATIONS

This application claims priority through U.S. Provisional Application 63/033,513 filed on Jun. 2, 2020.

### BACKGROUND

Labor availability, process efficiency and accuracy, and product damage affect detection and tracking of pallet pockets during automated material handling using a forklift or a pallet lift type vehicle where load positions vary and are not accurately known beforehand. Current solutions are slow, do not conduct tracking, and require a vehicle to be stationary and provide inputs such as expected distance from the vehicle.

### FIGURES

Various figures are included herein which illustrate aspects of embodiments of the disclosed inventions.

FIG. 1 is a diagrammatic view of an exemplary system';

FIG. 2 is an illustration of a point data cloud with a pallet;

FIG. 3 is an illustration of a point data cloud with a pallet segmented from a larger data cloud;

FIG. 4 is a flowchart of an exemplary method;

FIG. 5 is a flowchart of an exemplary classification and segmentation network set; and

FIGS. 6A-6C are exemplary graphic user interfaces.

### DESCRIPTION OF EXEMPLARY EMBODIMENTS

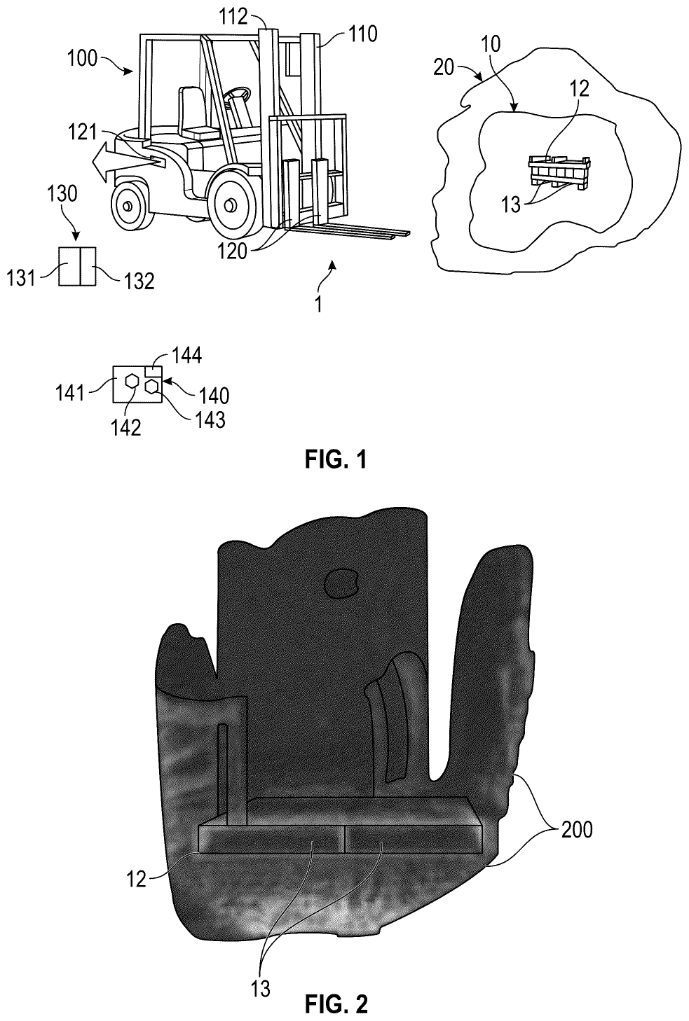

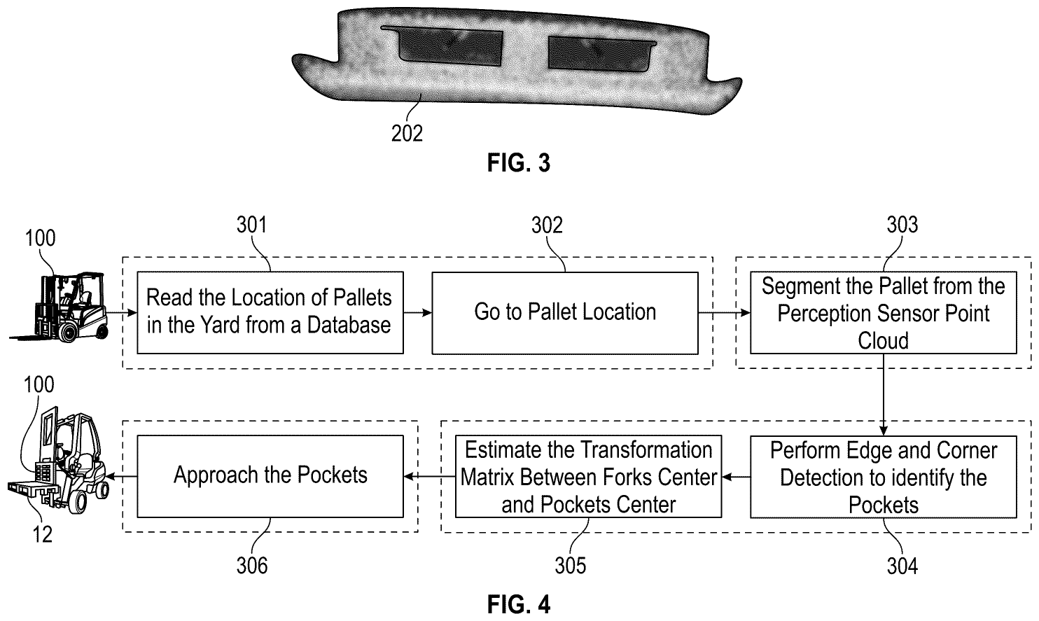

In general, as used herein, a “load” is pallet 12 (FIG. 1) and any materials located on pallet 12 or other loads or load carrying structures such as, but not limited to, car racks or other items that can be picked up using forklift fork. Generally, perception sensor point data cloud comprises pallet cloud data 200 (FIG. 2 and shown as well as segmented data 202 in FIG. 3) as well as data regarding and otherwise representative of background and surrounding areas. As used herein, “data cloud” and “cloud” mean a collection of data representing a two- or three-dimensional space as a collection of discrete data. Further, “point data cloud” is a software data structure created from a perception sensor disposed on or otherwise attached to vehicle 100.

In a first embodiment, referring generally to FIG. 1, system 1 for directing vehicle 100 using a detected and tracked pallet pocket comprises vehicle 100, where vehicle 100 may comprise a forklift, an autonomous such as an autonomous mobile robot (AMR), an automated guided vehicle (AGV), a remotely controlled vehicle, a mobile robot, or the like; navigation system 130; and command system 140. Navigation system 130 and command system 140 may be part of vehicle 100 or separate components located proximate to or remotely from vehicle 100.

In embodiments, vehicle 100 comprises one or more multidimensional physical space sensors 110 configured to scan pallet location space 10 which, in turn, is within a larger three-dimensional space 20, where pallet location space 10 is a two or three-dimensional physical space in which pallet 12 is located, and generate data sufficient to create a three-dimensional representation of pallet 12 within pallet location space 10; a set of vehicle forklift forks 120 and forklift fork positioner 121 operatively in communication with the set of vehicle forklift forks 120; navigation system 130; and command system 140.

Although system 1 is typically sensor agnostic, multidimensional physical space sensor 110 typically is one that produces three dimensional an RGB-D point data cloud such as point data cloud 200 (FIG. 2). Multidimensional physical space sensor 110 is typically mounted on vehicle 10 and may comprise a stereo camera suitable for both indoor and outdoor operations. In embodiments, multidimensional physical space sensor 110 comprises a sensor-specific driver, a deep learning approach for segmentation, a data collection and annotation module (if a deep learning approach is used), and a user interface and input to specify approximate pocket center points. One of ordinary skill in computer science arts understands that “deep learning” is a subset of machine learning in artificial intelligence (AI) that has networks capable of learning unsupervised from data that is unstructured or unlabeled (also known as deep neural learning or deep neural network). If deep learning is used, it typically requires a large data collection of the load objects of interest in order to train a segmentation model.

Navigation system 130 comprises vehicle mover 131, which is typically part of vehicle 100 such as a motor and steering system, and vehicle controller 132 operatively in communication with vehicle mover 131 and the set of vehicle forklift forks 120.

Command system 140 is configured to process and/or issue one or more commands and engage with, or otherwise direct, vehicle mover 131. Command system 140 typically comprises one or more processors 141; space generation software 142 resident in processor 141 and operatively in communication with multidimensional physical space sensors 110; and vehicle command software 143 resident in processor 141 and operatively in communication with vehicle controller 132.

Processor 141 may further control the process of directing vehicle 100 using a detected and tracked pallet pocket 13 by running vehicle controller 132 for closed-loop feedback. In embodiments, command system 141 further comprises an online learning system which improves as the system successfully/unsuccessfully picks up each load.

In embodiments, command system 140 further comprises a graphics processing unit (GPU) to process the sensor data, run offline training, run online model for segmentation and pallet pose estimation. As used herein, a “pose” are data descriptive of three-dimensional space as well as other characteristics of a center of pallet pocket 13 such as roll, pitch, and/or yaw.

As more fully described below, vehicle command software 142 comprises one or more modules operative to direct vehicle 100 to the location of pallet 12 in the three-dimensional pallet location space 10; to track vehicle 100 as it approaches pallet 12 in pallet location space 10; to provide a position of centers of the set of pallet pockets 13 to vehicle controller 132; to guide vehicle 100 until the set of vehicle forklift forks 120 are received into a set of selected pallet pockets 13 of the set of pallet pockets 13; and to direct engagement of vehicle forklift forks 120 once they are received into the set of selected pallet pockets 13.

As described more fully below, space generation software 143 comprises one or more modules typically configured to create a representation of a three-dimensional pallet location space 10 as part of a larger three-dimensional space 20 using data from one or more multidimensional physical space sensors 110 sufficient to create the three-dimensional representation of pallet location space 10, in part by using data from multidimensional physical space sensor 110 to generate perception point data cloud 200 (FIG. 2); determine a location of pallet 12 in the three-dimensional pallet location space 10; and segment data representative of pallet 12 from perception sensor point data cloud 200 such as segmented pallet cloud 202 (FIG. 3) which segments pallet 12 and/or its load from its background and typically also eliminates all data points in point data cloud 200 except those associated with pallet 12 and/or its load; determine a location of a set of pallet pockets 13 in pallet 12 which can accept the set of vehicle forklift forks 120 therein; and feed the segmented load into a predetermined set of algorithms, typically resident in vehicle 100, which are used to identify the set of pallet pockets 13 in pallet 12 which can accept the set of vehicle forklift forks 120 therein and determine a center for each such pallet pocket 13 of the set of pallet pockets 13.

Although command system 140 may be located in whole or in part on or within vehicle 100, in embodiments command system 140 may be at least partially disposed remotely from vehicle 100. In these embodiments, vehicle 100 further comprises data transceiver 112 operatively in communication vehicle controller 132 and multidimensional physical space sensor 110, and command system 140 comprises data transceiver 144 operatively in communication with vehicle data transceiver 112 and processor 141.

In the operation of exemplary methods, referring still to FIG. 1 and additionally to FIG. 4, pallet pocket 13 may be detected and tracked where load positions vary and are not accurately known beforehand during automated material handling using vehicle 100 as described above by determining a location of pallet 12 in pallet location space 10, where pallet 12 comprises a set of pallet pockets 13 dimensioned to accept forklift fork 120 therein (301); issuing one or more commands to direct vehicle mover 131 to move vehicle 100 from a current position to the location of pallet 12 in pallet location space 10 (302); using multidimensional physical space sensor 110 to generate perception sensor point data cloud 200 (FIG. 2); using space generation software 143 to segment pallet 12 from perception sensor point data cloud 200 and to generate a segmented load (303); feeding the segmented load into a predetermined set of algorithms useful to identify the set of pallet pockets 13, the identification of the set of pallet pockets 13 comprising a determination of a center position for each pallet pocket 13 of the set of pallet pockets 13 (304,305); and using vehicle command software 142 to direct vehicle 100 towards pallet 12 in pallet location space 10 and tracking vehicle 100 as it approaches pallet 12 in pallet location space 10 while providing the center position of the set of pallet pockets 13 to vehicle controller 132 to guide vehicle 100 towards pallet 12 until the set of vehicle forklift forks 120 are received into the set of pallet pockets 13 (306). Typically, determining a location of a pallet in a pallet location space occurs via software that computes the location of pallet 12 through imaging such as computer vision and image processing. Directing vehicle 100 typically occurs by having controller 132 compute an error determined to be between the desired location of vehicle 100, e.g., location of pallet 12, and a then current location of vehicle 100.

These steps can occur in any appropriate sequence to accomplish the task at hand. Further, these steps typically occur in real-time or near real-time while vehicle 100 is moving, in part because shorter handling times can lead to increased throughput.

Once the set of vehicle forklift forks 120 are received into the set of pallet pockets 13, vehicle command software 142 typically issues one or more commands to forklift fork positioner 121 to engage set of forklift forks 120 with pallet 12.

In embodiments, an online learning system is used which improves performance of system 1 as it successfully/unsuccessfully picks up each pallet 12.

Navigation system 130 is also typically operative to use data from sensor point data cloud 200 (FIG. 2) instead of image data because images are susceptible to lighting, color and noise disturbances and in an outdoor environment, it is impossible to create a training dataset for every possible scenario. Using point data cloud help avoid these issues, e.g., geometrical details typically remain the same even if there are variations in color, texture and aesthetic design of an object. Also, this allows capture of sensor point data clouds 200 of different types of pallets in both indoor and outdoor environments and labeling them based on the perceived scene.

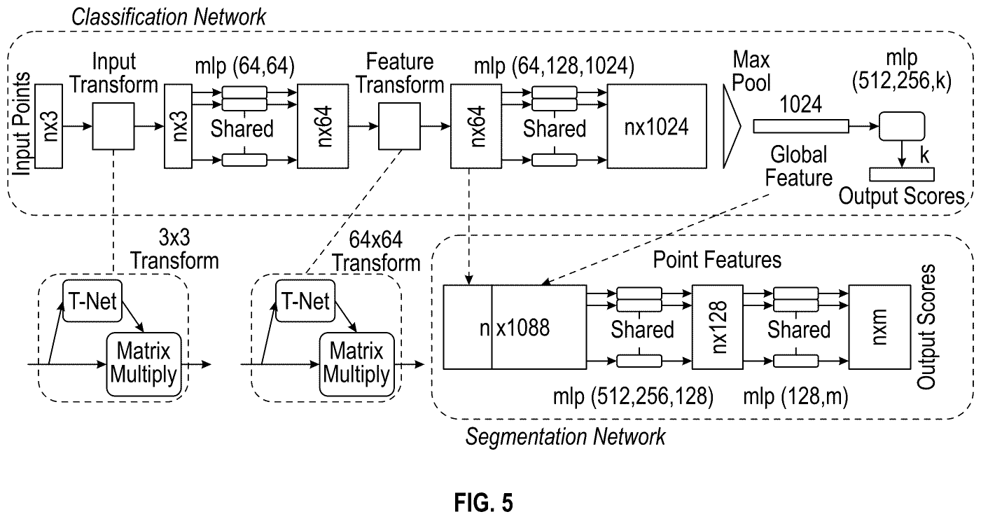

Referring generally to FIG. 5, typically, navigation system 130 receives a ground normal set of data, with respect to a sensor, from a vehicle control module or high-level executive module and uses a classifier, which is software, to classify pallets 12 irrespective of lighting conditions and other obstructions in the scene, i.e., present in pallet location space 10. The classifier is typically invariant to rotation, translation, skew and dimension changes of an object such as pallet 12; trainable and scalable based on different scenarios; able to perform well when there are scene obstructions; and able to classify the objects reliably under outdoor weather conditions. The classifier is also typically configured to use a classification network which takes “n” points as input, applies input and feature transformations, and then aggregates point features by max pooling. The classification network typically comprises a segmentation network which is an extension to the classification network, the classification network operative to receive a set of input points which are data present in pallet point data cloud 200; transform the set of input points into a one dimensional vector of size N points to feed to the network; process the transformed input points into a first multi-layer perceptron; transform an output of the multi-layer perceptron into a pose invariant/origin and scale invariant feature space; provide the pose invariant/origin and scale invariant feature space to a max pool; create a set of global features such as features that consider clusters/point cloud as a whole and not point-to-point/neighboring point interactions; provide the set of local features obtained from the first multi-layer perceptron and the set of global features to a segmentation network which generates a set of point features to a first set of output scores and concatenates global and local features and outputs per point scores; and provide the set of global features to a second set of output scores.

Determination of the center for each pallet pocket 13 of the set of pallet pockets 13 may comprise performing edge and corner detection by using one or more edge detection methods such as Canny edge detection.

In situations where the set of pockets 12 and their centers are not determined, and/or explicitly detected, to be within a predefined confidence level, e.g., where sensor point data cloud 200 data are very noisy and sparse, the method further comprises performing clustering and principal component analyses (PCA) on sensor point data cloud 200 for estimating an initial pose of pallet 12; extracting a thin slice of the pallet cloud data from the initial pose containing a front face of the pallet, where “thin” means data description of a determination to a few cm such as to around 3-4 cm; using the thin slice for refinement of pallet pose using PCA; transforming the extracted thin slice of sensor point data cloud 200 to a normalized coordinate system; aligning the extracted thin slice with principal axes of the normalized coordinate system to create a transform cloud, which is the result of pallet point cloud 200 undergoing the transformation to the normalized coordinate system, as if the transformed cloud is viewed by a virtual sensor looking face-on toward a center of pallet 12; and generating a depth map from the transform cloud. One of ordinary skill in computer science arts understands that a “thin slice” consists of a subset of data sufficient to make a desired determination that excludes data that may be unnecessary or otherwise only indirectly affect a determination.

Pallet 12 which has been determined to be in the depth map may or may not be aligned. In situations where pallet 12 in the depth map is aligned, the method further comprises extracting pallet 12 from the transform cloud by vertically dividing the extracted pallet 12 into two parts with respect to the normalized coordinate system such as by splitting pallet 12 in the middle into two pallet pockets 13; computing a weighted average of depth values associated with each part such as by extracting depth values from pallet point cloud 200 and using a software algorithm to perform a weighted average of the depth values of the points associated with each part of the split pallet; and using the weighted average as one of the pocket centers. Using the weighted average may be by using a randomly picked weighted average for centers of one or both pallet pocket 13 such as when both centers are the same.

In most embodiments, if results are not satisfactory, the method may further comprise projecting sensor point data cloud 200 along a ground normal to obtain a projected mask; using line fitting for detection and fitting of the line closest to the sensor (with minimal ‘x’ (depth)); using the fitted line as a projection of the pallet's front face for estimating the surface normal of pallet's front face; using the estimated surface normal of the pallet's front face for estimating pallet's pose; and transforming sensor point data cloud 200 by inverse transform of pallet's estimated pose, equivalent to viewing the pallet face-on from a virtual sensor placed right in front of pallet's face, so that pallet centers can be more reliably located. The line fitting may be accomplished random sample consensus (RANSAC) which is an iterative method to estimate parameters of a mathematical model from a set of observed data that contains outliers, when outliers are to be accorded no influence on the values of the estimates. One of ordinary skill in computer science understands that RANSAC is an iterative method to estimate parameters of a mathematical model from a set of observed data that contains outliers, when outliers are to be accorded no influence on the values of the estimates.

In most embodiments, vehicle 100 may be issued one or more commands which direct vehicle 100 to either look, i.e., scan, for a specific load to pick up using an interrogatable identifier, pick a load at random, or proceed following a predetermined heuristic. The directives may be issued from command system 140 directing vehicle 100 to navigate to a certain location and, optionally, identify a specific load for handling operations. The heuristic may comprise one or more algorithms to pick a load closest to vehicle 100, pick a biggest load first, or the like, or the combination thereof. In such a situation, the interrogatable identifier may comprise an optically scannable barcode, an optically scannable QR code, or a radio frequency identifier (RFID), or the like, or a combination thereof. Further, the heuristic may comprise selection of a load closest to vehicle 100 based on its approaching direction.

In situations where pocket pockets 13 and their centers of pallet 12 are not explicitly detected such as when sensor point data cloud 200 data are very noisy and sparse, the method may further comprise representing positions of one or more pallets 12 in pallet location space 10 as part of a three-dimensional (3D) scene, generated by one or more multidimensional physical space sensors 110, such as a stereo camera for both indoor and outdoor operations, mounted on vehicle 100 as vehicle 100 approaches a load position; and segmenting pallet 12 from the 3D scene using a variety of potential techniques, including color, model matching, or Deep Learning.

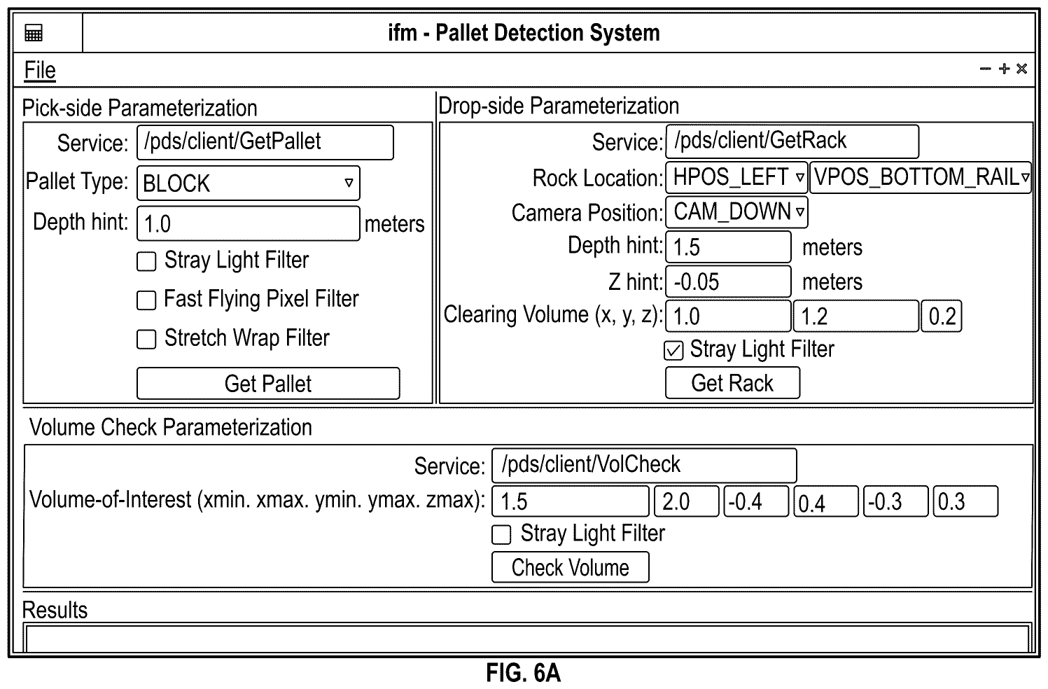

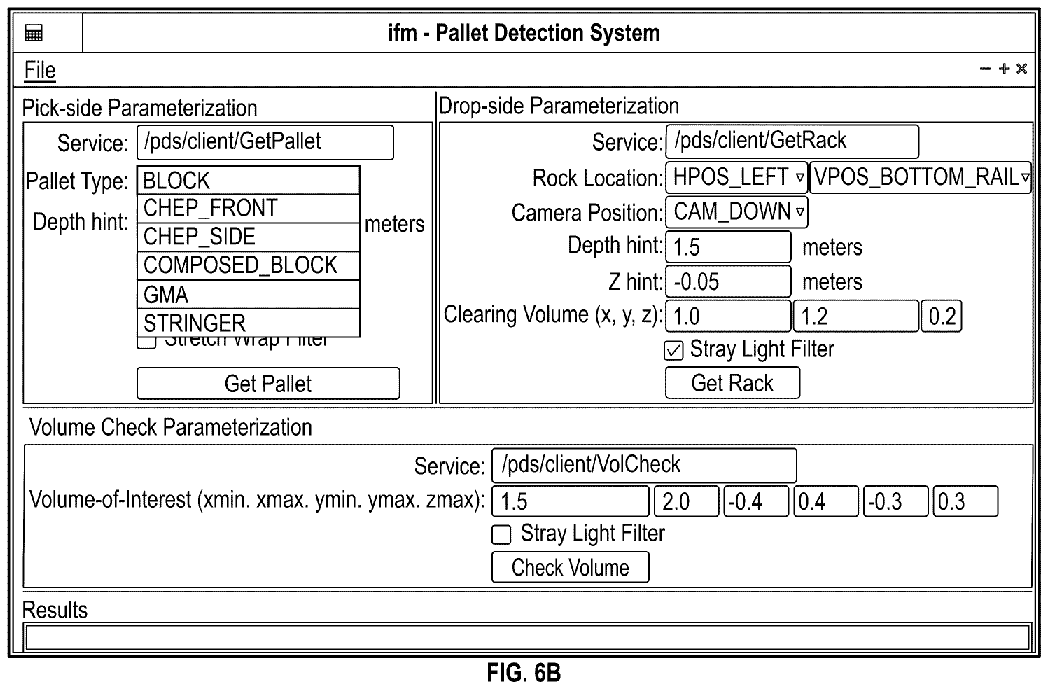

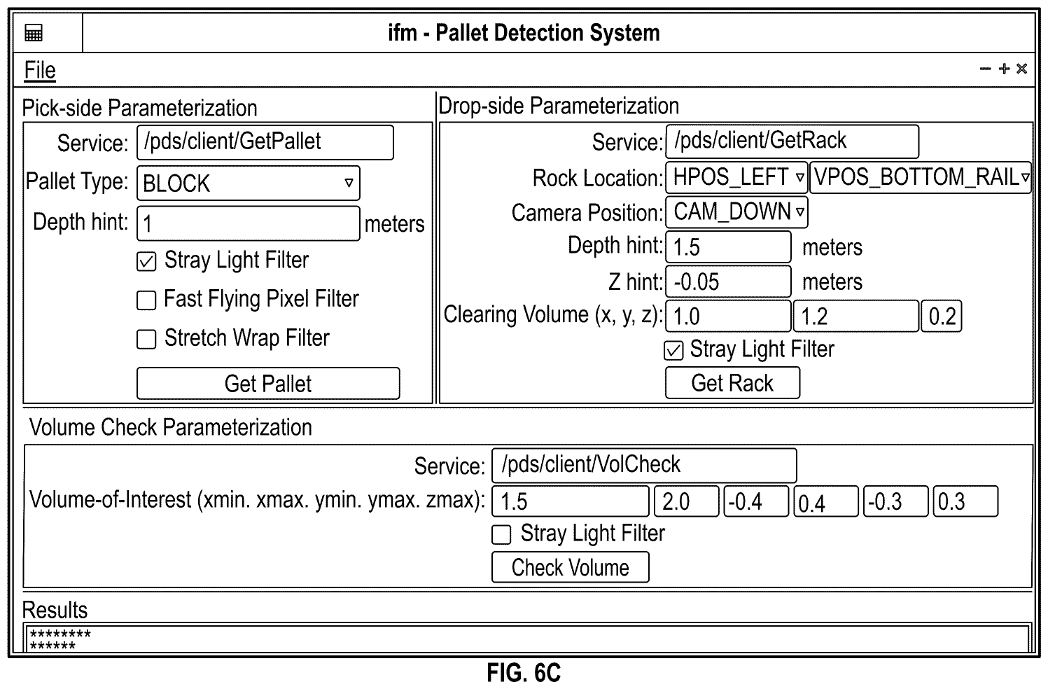

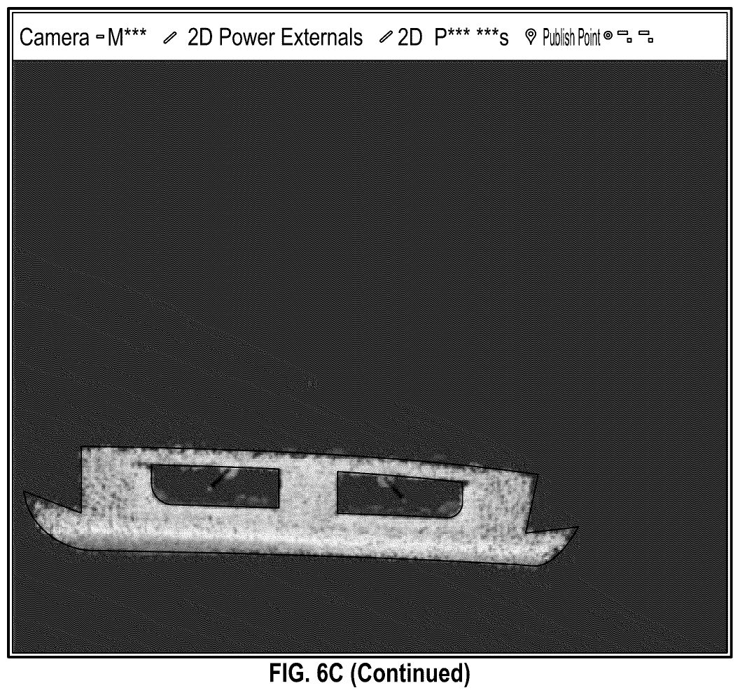

Referring generally to FIGS. 6A-6C, if segmentation fails or initial positioning cannot be determined, user input through a graphical user interface (GUI), e.g., from a remote operator, can specify approximate pocket center points that allow a tracking algorithm to begin so vehicle 100 can approach and handle the load.

For a stand-alone version, ground normal is estimated from perception sensor point data cloud 200. Perception sensor point data cloud 200 of pallet 12 of interest may be provided by a software which segments pallet cloud 202 (FIG. 3) from background in perception sensor point data cloud 200.

Tracking may be effected or otherwise carried out using a particle filter technique, such as by estimating an initial pose, using the initial pose as a reference pose, and setting an associated target cloud as a reference cloud.

In embodiments, relative transformations of particles are randomly selected based on initial noise covariances set by users at the beginning of tracking, and then by used defined step covariances. There are many programmable parameters, including number of particles, for users to set by trade-off between processing speed and robustness of tracking.

To speed up processing, only a small region of interest (ROI) surrounding the target of interest may be used to matched against the reference cloud. The ROI is currently set based on estimated poses of previous data frames. They could be set by taking the estimated motion from the previous frame into consideration.

It should be pointed out that tracking is able to estimate only motion between the current target cloud and the reference cloud. If initial estimated pose is not accurate, there will be offset (defined by the error in the initial estimated) in updated poses computed from tracker, and could not be minimized (or corrected) through tracking. It is crucial to have initial pose estimated as accurate as possible.

The foregoing disclosure and description of the inventions are illustrative and explanatory. Various changes in the size, shape, and materials, as well as in the details of the illustrative construction and/or an illustrative method may be made without departing from the spirit of the invention.

1. A method of detecting and tracking a pallet pocket during automated material handling using a forklift where load positions vary and are not accurately known beforehand, comprising:
determining a location of a pallet in a pallet location space, the pallet comprising a set of pallet pockets dimensioned to accept a forklift fork therein;
issuing a command to a navigation system of a vehicle to direct a vehicle mover of the vehicle to move the vehicle to the location of the pallet in the pallet location space;
using a multidimensional physical space sensor of the vehicle to generate a perception sensor point data cloud;
using space generation software resident in a processor of a command system, which is operatively in communication with the vehicle mover and a forklift fork positioner of the vehicle, to segment the pallet from pallet cloud data derived from the perception sensor point data cloud and to generate a segmented load;
feeding the segmented load into a predetermined set of algorithms useful to identify the set of pallet pockets, the identification of the set of pallet pockets comprising a determination of a center position for each pallet pocket of the set of pallet pockets; and
using vehicle command software resident in the processor and operatively in communication a vehicle controller of the vehicle to:
direct the vehicle towards the pallet in the pallet location space and track the vehicle as it approaches the pallet in the pallet location space;
provide the center position of the set of pallet pockets to the vehicle controller to guide the vehicle towards the pallet until the set of vehicle forklift forks are received into the set of pallet pockets; and
command the forklift fork positioner to engage the set of forklift forks with the pallet.

2. The method of detecting and tracking a pallet pocket during automated material handling using a forklift where load positions vary and are not accurately known beforehand of claim 1, wherein the set of pallet pockets and their centers are determined to be outside a predefined confidence level, the method further comprising:
performing clustering and principal component analyses (PCA) on the pallet cloud data for estimating an initial pose of the pallet;
extracting a thin slice of the pallet cloud data from the initial pose containing a front face of the pallet;
using the thin slice for refinement of pallet pose using PCA;
transforming the extracted thin slice of the pallet cloud data to a normalized coordinate system;
aligning the extracted thin slice with principal axes of the normalized coordinate system to create a transform cloud which is a result of the pallet point cloud transformed having been transformed to the normalized coordinate system as if the transformed cloud is viewed by a virtual sensor looking face-on toward a center of the pallet; and
generating a depth map from the transform cloud.

3. The method of detecting and tracking a pallet pocket during automated material handling using a forklift where load positions vary and are not accurately known beforehand of claim 2, wherein the pallet in the depth map is aligned, the method further comprising extracting the pallet in the transform cloud by:
vertically dividing the extracted pallet into two parts with respect to the normalized coordinate system;
computing a weighted average of depth values associated with each part; and
using the weighted average as one of the pallet pocket centers.

4. The method of detecting and tracking a pallet pocket during automated material handling using a forklift where load positions vary and are not accurately known beforehand of claim 3, further comprising:
determining if results obtained are not satisfactory; and
if the results obtained are not satisfactory:
projecting the pallet cloud along a ground normal to obtain a projected mask;
using line fitting for detection and fitting of the line closest to the sensor (with minimal x (depth)) to create a fitted line;
using the fitted line as a projection of the pallet's front face for estimating a surface normal of pallet's front face and creating an estimated surface normal of the pallet's front face;
using the estimated surface normal of the pallet's front face for estimating and creating a pallet's pose; and
transforming the pallet cloud by inverse transform of pallet's estimated pose, equivalent to viewing the pallet face-on from a virtual sensor placed right in front of pallet's face, so that pallet centers can be more reliably located.

5. The method of detecting and tracking a pallet pocket during automated material handling using a forklift where load positions vary and are not accurately known beforehand of claim 1, further comprising issuing a command to the vehicle directing the vehicle to either look for a specific load to pick up using an interrogatable identifier, pick a load at random, or proceed following a predetermined heuristic.

6. The method of detecting and tracking a pallet pocket during automated material handling using a forklift where load positions vary and are not accurately known beforehand of claim 5, wherein the interrogatable identifier comprises an optically scannable barcode, an optically scannable QR code, or a radio frequency identifier (RFID).

7. The method of detecting and tracking a pallet pocket during automated material handling using a forklift where load positions vary and are not accurately known beforehand of claim 1, wherein:
pallet positions in the pallet location space are represented as part of a three-dimensional (3D) scene, generated by a sensor mounted on the vehicle as the vehicle approaches a load position; and
the pallet is segmented from the 3D scene.

8. The method of detecting and tracking a pallet pocket during automated material handling using a forklift where load positions vary and are not accurately known beforehand of claim 1, wherein the method further comprises using an online learning system which improves as it successfully/unsuccessfully picks up each pallet.

9. The method of detecting and tracking a pallet pocket during automated material handling using a forklift where load positions vary and are not accurately known beforehand of claim 1, wherein the software is operative to:
use point cloud data instead of image data; and
capture of point clouds of different types of pallets in both indoor and outdoor environments and labeling them based on scene.

10. The method of detecting and tracking a pallet pocket during automated material handling using a forklift where load positions vary and are not accurately known beforehand of claim 1, wherein tracking is carried out using a particle filter technique, comprising:
estimating an initial pose;
using the initial pose as a reference pose; and
setting an associated target cloud as a reference cloud.

11. A system for directing a vehicle using a detected and tracked pallet pocket, comprising:
a vehicle, comprising:
a multidimensional physical space sensor configured to scan a pallet location space from within a larger three-dimensional space and generate data sufficient to create a three-dimensional representation of the pallet location space within the larger three-dimensional space;
a set of vehicle forklift forks;
a forklift fork positioner operatively in communication with the set of vehicle forklift forks; and
a navigation system, comprising:
a vehicle mover; and
a vehicle controller operatively in communication with the vehicle mover and the set of vehicle forklift forks; and
a command system configured to process a command and engage the vehicle mover, the command system comprising:
a processor;
space generation software resident in the processor and operatively in communication with the sensor, the space generation software configured to:
create a representation of a three-dimensional pallet location space as part of the larger three-dimensional space using the data from the sensor sufficient to create the three-dimensional representation of the pallet location space, in part by using data from the multidimensional physical space sensor to generate a perception sensor point data cloud;
determine a location of a pallet in the three-dimensional pallet location space;
segment the pallet from the perception sensor point cloud;
generate a segmented load;
determine a location of a set of pallet pockets in the pallet which can accept the fork therein; and
feed the segmented load into a predetermined set of algorithms which are used to identify the set of pallet pockets in the pallet which can accept the fork therein and determine a center for each pallet pocket of the set of pallet pockets; and
vehicle command software resident in the processor and operatively in communication with the vehicle controller and the forklift fork positioner, the vehicle command software operative to:
direct the vehicle to the location of the pallet in the three-dimensional pallet location space;
provide a position of the centers of the set of pallet pockets to the vehicle controller;
guide the vehicle until the set of vehicle forklift forks are received into a set of pallet pockets of the set of pallet pockets;
track the vehicle as it approaches the pallet in the pallet location space; and
engage the set of vehicle forklift forks.

12. The system for directing a vehicle using a detected and tracked pallet pocket of claim 11, wherein the command system further comprises a graphics processing unit (GPU) to process the sensor data, run offline training, run online model for segmentation and pallet pose estimation.

13. The system for directing a vehicle using a detected and tracked pallet pocket of claim 11, wherein the processor controls the process and runs to the vehicle controller for closed-loop feedback.

14. The system for directing a vehicle using a detected and tracked pallet pocket of claim 11, wherein the command system further comprises an online learning system which improves as the system successfully/unsuccessfully picks up each load.

15. The system for directing a vehicle using a detected and tracked pallet pocket of claim 11, wherein the multidimensional physical space sensor comprises a stereo camera for both indoor and outdoor operations mounted on the vehicle.

16. The system for directing a vehicle using a detected and tracked pallet pocket of claim 11, wherein the sensor comprises a sensor configured to generate a three-dimensional RGB-D image.

17. The system for directing a vehicle using a detected and tracked pallet pocket of claim 11, wherein:
the command system is at least partially disposed remotely from the vehicle;
the vehicle comprises a data transceiver operatively in communication with the vehicle controller and the sensor; and
the command system comprises a data transceiver operatively in communication with the vehicle data transceiver and the processor.
